(19) United States
(12) Patent Application Publication
(10) Pub. No.: US 2014/0343969 A1
(43) Pub. Date: Nov. 20, 2014

(54) IMMEDIATE GIFT ANNUITY PORTAL

(71) Applicant: GAN LICENSING, LLC, DALLAS, TX (US)

(72) Inventor: RICK HENDERSON, MONROE, CT (US)

(21) Appl. No.: 13/938,890

(22) Filed: Jul. 10, 2013

Related U.S. Application Data
(60) Provisional application No. 61/824,035, filed on May 16, 2013.

(51) Int. Cl. G06Q 40/00; G06Q 30/02

(52) U.S. Cl. CPC G06Q 40/08; G06Q 30/0279
USPC 705/4

(57) ABSTRACT

I provide a cloud-based portal for a nonprofit organization of any size to offer immediate gift annuities to prospective donors.

### CROSS-REFERENCE TO RELATED APPLICATION

This application claims the benefit of U.S. Provisional Application No. 61/824,035, filed May 16, 2013.

### STATEMENT REGARDING FEDERALLY SPONSORED RESEARCH OR DEVELOPMENT

(not applicable)

### NAMES OF PARTIES TO A JOINT RESEARCH AGREEMENT

(not applicable)

### REFERENCE TO SEQUENCE LISTING, A TABLE OR A COMPUTER PROGRAM LISTING COMPACT DISC APPENDIX

(not applicable)

### FIELD OF THE INVENTION

This invention relates to cloud-based software which creates means for nonprofit organizations to market and offer immediate gift annuity plans to prospective donors.

### BACKGROUND OF THE INVENTION

This invention was created to provide 501(c)(3) organizations (hereinafter “nonprofits”) the opportunity to raise immediate cash gifts through the gift annuity model while simultaneously eliminating risks, liabilities and waiting periods associated with the traditional format of this gift design. While any size nonprofit can utilize this invention, it is particularly geared toward small to medium sized nonprofits. To understand this new invention it is helpful to understand the background and limitations of the traditional gift annuity model. The following will generally describe the traditional model of a gift annuity and then review a gift annuity in the context of our invention.

Traditional Gift Annuity—Definition, Risk and Liability, Waiting Period, Compliance, Expertise and Knowledge

Definition—Traditional gift annuities are a charitable gifting design by which a donor can give a gift of assets to a nonprofit of their choice. This gift becomes a part of the nonprofit's assets. In exchange for this gift, the donor receives certain tax deductions and a fixed and guaranteed annual stream of income until death. At the time of the donor's death, the nonprofit realizes the remaining amount of assets.

Risk and Liability—Until the donor's death, the nonprofit holds all of the risk and liability through having to manage the asset in order to guarantee the payments to the donor. An additional liability and burden to the nonprofit is the requirement and expectation that they be aware of and must comply with complex state laws regulating the payout rates and how nonprofits must track the value of these gifts. Large nonprofits will have entire development, advancement or fundraising offices dedicated to these efforts. Staff specialists manage the regulatory paperwork, internal bookkeeping and donor relations. It is a team effort. Smaller and medium sized nonprofits depend on gifts as much as, if not more so, than larger ones. The overhead and training associated with administering gift annuities, however, is beyond the means of most of these smaller nonprofits. This industry needs a way for smaller and medium sized nonprofits to accept and administer gift annuities without the following: risk and liability, investing in costly training and expensive staff and the difficulty of regulatory paperwork.

Waiting Period—Upon executing a traditional gift annuity, the nonprofit is burdened by the state's requirement that the nonprofit hold the assets in reserve to ensure the income payments to the donor. Holding the assets in reserve until the donor's death creates the problem of an unknown waiting period during which the nonprofit must be prepared to manage the asset and make payments to the donor. If the donor should live well beyond their life expectancy, the nonprofit must continue to pay the donor their contracted income until death, a burden for which the nonprofit many not be fully prepared.

Compliance—Under the traditional gift annuity model there is a great deal of compliance imposed on the nonprofit. Many nonprofits adhere to the guidelines set by the American Council on Gift Annuities (ACGA). The ACGA is an association that promotes best practices in the administration of charitable gift annuities. ACGA has a wealth of resources for its members. It publishes annual guideline payout rates, provides educational information and helps members keep abreast of changes in the law. If the nonprofit does not use the currently suggested gift annuity rates published by the ACGA, regulating states will require the nonprofit to prove, through the use of an actuary, that the nonprofit's assumptions used in setting its annuity rates comply with that state's regulatory law. Other requirements include using the actual earnings rate of the nonprofit's gift annuity fund and not the more conservative assumptions used by ACGA.

Expertise and Knowledge—Requirements for the nonprofits administering these gift annuities include highly specialized accounting, auditing and bookkeeping skills, knowledge of securities and insurance law, as well as the continued labor intensive effort of maintaining donor relations. Many small to medium sized nonprofits do not have these resources. Hiring or outsourcing for these skills puts a burden on the nonprofit's personnel and finances.

Immediate Gift Annuity Portal—Definition, Risk and Liability, Waiting Period, Compliance, Expertise and Knowledge

Definition—An immediate gift annuity portal is a creative, cloud-based, fundraising software that provides nonprofits the ability to offer their donors a gift annuity platform resulting in immediate cash gifts to the nonprofit while simultaneously eliminating the risks, liabilities and waiting periods for the nonprofit and the donor.

Risk and Liability Eliminated—With this invention, the nonprofit organization assumes no risk and liability. The part of the gift that would traditionally stay with and be managed by the nonprofit is now placed with and invested by the largest commercial annuity companies in America. By administering the gift annuity in this way, the nonprofit is no longer responsible for the annual payments to the donor. Again, the payment comes from the largest commercial annuity companies in America which have much more stability than the medium to small nonprofit. By not employing their own gift annuity model, the nonprofit is no longer required to have reserve requirements. Moreover, the risk to the donor is eliminated, because the nonprofit is no longer responsible for maintaining a reserve. Knowing that their payments are fully guaranteed by a top rated annuity company will allow the donor some peace of mind, knowing that payments will continue.

Waiting Period Eliminated—With this invention there is no longer a waiting period for the nonprofit to receive their portion of the gift. An immediate gift annuity portal utilizes the payout rates suggested by the ACGA. The donor purchases and uses from an annuity provider a Single Premium Immediate Annuity (SPIA) to guarantee the ACGA payout. In this way, only a portion of the cash gift from the donor is needed to invest with the annuity. This immediate gift annuity portal works because the donor is going to receive the same income benefits as with a traditional gift annuity. The advantage of the SPIA is its higher payout and that it does not require 100% of the assets to generate the same income. The amount not used for the SPIA deposit is given as a cash gift to the nonprofit.

Compliance Requirement Shifted from Nonprofit—Because the remainder of the gift asset is placed with highly rated commercial annuity companies, the nonprofit and donor are both assured that these large companies are following state and other legal requirements. They are able to comply with laws that vary from state to state in how much an annuity company needs to have in reserves to guarantee fixed income payments to the donor for life.

Expertise and Knowledge Shifted from Nonprofit—In the traditional gift annuity model, the nonprofit accepts the asset from the donor and assumes responsibility for all paperwork and managing the assets. The nonprofit would have to register with the Attorney General's office in each state where it would like to offer gift annuities. In addition, it would be responsible for all necessary documentation for income tax purposes, governmental filing fees, etc. With this immediate gift annuity portal, the nonprofit is not responsible for any paperwork. All annuity paperwork, IRS forms, 1099s and all asset management are handled by a central administration team and the commercial SPIA provider. Lack of expertise and knowledge in managing the gift annuity are the primary reasons that hundreds of thousands of nonprofits do not and cannot employ a traditional gift annuity model. What makes the immediate gift annuity portal a unique invention is that it shifts this expertise and knowledge off the nonprofit.

### BRIEF SUMMARY OF THE INVENTION

I provide cloud-based software which creates a portal for nonprofit organizations to offer immediate gift annuity products to their potential donors. This comes in the form of a proposal for the donor to enter into a contract with the nonprofit. This proposal presents, at a glance, the present and future advantages to both the nonprofit and the donor of an immediate gift annuity vehicle over a traditional gift annuity. Through this software, a nonprofit can submit to a server, from any Internet-connected device, basic personal and financial information from a prospective donor.

Administering Nonprofit Account Information and User Access

Four levels of users have access to this system. High-ranking back office administrators (“super administrators”) have the most access. They are responsible for managing contact information for nonprofit users, controlling user access to the system, managing submitted proposals and periodically updating the system with the IRS Applicable Federal Rate (AFR) and the prevailing ACGA payout rate. Super administrators can also create, view or delete proposals on behalf of a nonprofit.

Individual nonprofit users have the least access. They can create, view, delete or submit to central administration their own proposals. A nonprofit manager may create, view, delete or submit his own proposals, plus those created by other employees within the organization. Lower-ranking central system administrators can create, view, delete or submit proposals of any nonprofit organization.

To begin the process, a super administrator collects basic contact information from prospective nonprofit users, such as name, website address, e-mail address and phone. The software saves this information in a first system database for later access. The super administrator can view, edit or delete nonprofit contact information at any time. The software will incorporate this information into any future proposals.

To allow the nonprofit access to the software, the super administrator must create a user account. The super administrator chooses a username, a password, and assigns a security level. The super administrator creates accounts for all system users in a similar way, even other administrators. The security level determines the subsystems to which a user has access. The super administrator saves this information to a second database in the software. The super administrator can then edit or delete any user access at any time.

Creating Proposals

Once a user, whether nonprofit, individual, manager, central administrator or super administrator, has an account, he may access the software and create proposals for any prospective donor. The user logs onto his account through a standard web portal. The software verifies the user's credentials. The software gives the user the choice of creating a new proposal or viewing an existing proposal.

A proposal has three components. One is the income benefits and tax consequences of opening a traditional gift annuity. The second is the income benefit and tax consequences of opening an immediate gift annuity. The third is the income benefits and tax consequences of opening an immediate gift annuity with principal guarantee. The software uses donor biographical information along with accepted financial and investment benchmarks to calculate side by side the advantages of each product.

To calculate the income and tax consequences of a traditional gift annuity, the software first creates a web page containing a form. This form prompts the user to provide a donor's personal information, gift design, income tax rate and desired amount of gift annuity. The gift design may be either individual or joint. The user submits this information to a third database in the server for storage.

The software sends all of this information to a second web page. At the second page, the software calculates the annual annuity benefit, taxable portion of annual income, tax-free portion of annual income, income tax deduction, income tax savings and tax exclusion ratio. The software displays these calculations, along with the donor biographical information, on the user's screen. The user can then continue to a third, then fourth web page where the system calculates the same information for an immediate gift annuity, with or without principal guarantee. Thus, there are three points of comparison: traditional gift annuity, an immediate gift annuity without principal guarantee and immediate gift annuity with principal guarantee.

To obtain data about an immediate gift annuity without principal guarantee, the server makes a first call to an online financial data exchange. The financial data exchange site compiles statistics about a variety of annuity products. The exchange surveys, in real time, annuity providers throughout the U.S. market for comparative rates on the product of interest, industry ratings and guarantees. Here, the server inquires about SPIA. In reply, the exchange feeds to the server an XML list of annuity providers and their corresponding payout, taxable portion of payout and industry rating. The software then saves this data as an XML file on the server. The software sorts through the list and identifies the provider with the combined highest payout and highest industry rating. The software then displays on the user's local terminal a two-column table comparing this immediate gift annuity product with the traditional model.

To obtain data about an immediate gift annuity with principal guarantee, the user prompts the software to make a second call to the online financial data exchange. The financial data exchange sends a new set of data in XML format that the software then saves as a second XML file on the server. This second set of data corresponds to an immediate gift annuity with principal guarantee. These three sets of information complete the proposal.

The software creates and displays a three-column preview of the proposal. The user can see from his local terminal, at a glance, the advantages and disadvantages of each gift annuity product. He then has the option to create a .pdf version to print and show the prospective donor. At this point, the user can save the proposal, delete it or submit it to the back office for further processing.

### BRIEF DESCRIPTION OF THE DRAWINGS

FIG. 1 is a block schematic of cloud-based immediate gift annuity proposal creation software, server and computer-implemented method in accordance with an embodiment of this invention.

FIG. 1A is a screen shot of a main menu as displayed on a user's internet-ready computing device.

FIG. 1B is a block schematic of a main menu.

FIG. 2-5 are block schematics of menu options available to particular users.

FIG. 6-14 are block schematics outlining how the software creates immediate gift annuity proposals.

FIG. 15 is a block schematic of the Manage Nonprofits submenu.

FIG. 16 is a block schematic of the Manage Users submenu.

FIG. 17 is a block schematic of the Manage Submitted Proposals submenu.

FIG. 18 is a block schematic of the Submit A Proposal submenu.

FIG. 19 shows a page from a sample completed proposal made in accordance with this invention.

### DETAILED DESCRIPTION OF THE INVENTION

The drawings and text that follow provide further clarification for one skilled in the art. For simplicity and consistency, I use the pronouns “he” and “his,” with the understanding this can refer to a user or administrator of any gender.

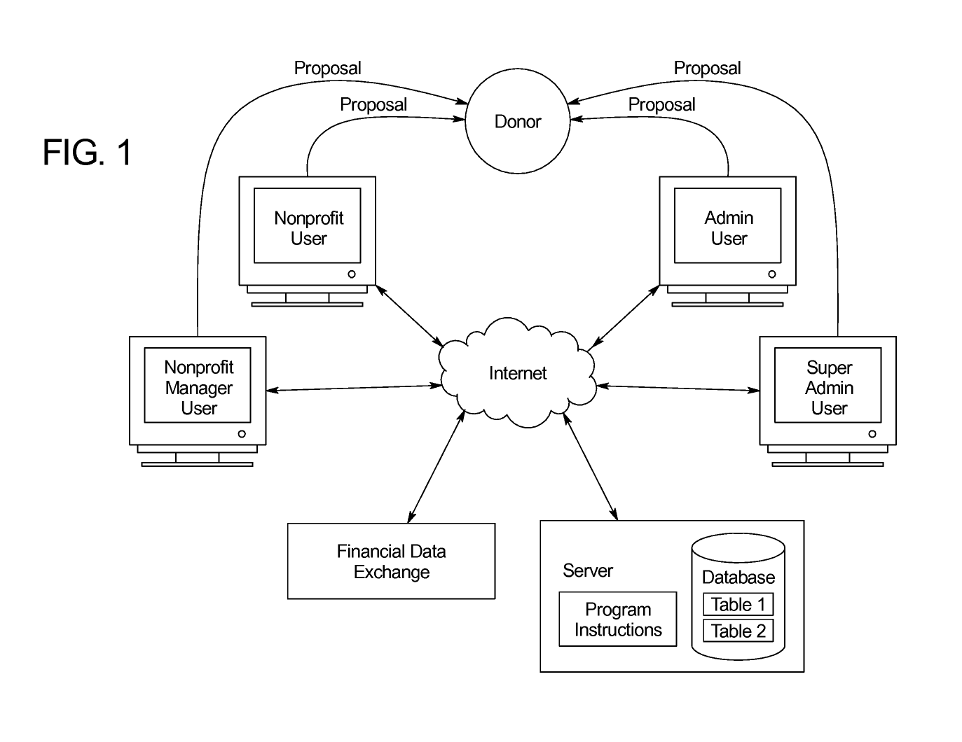

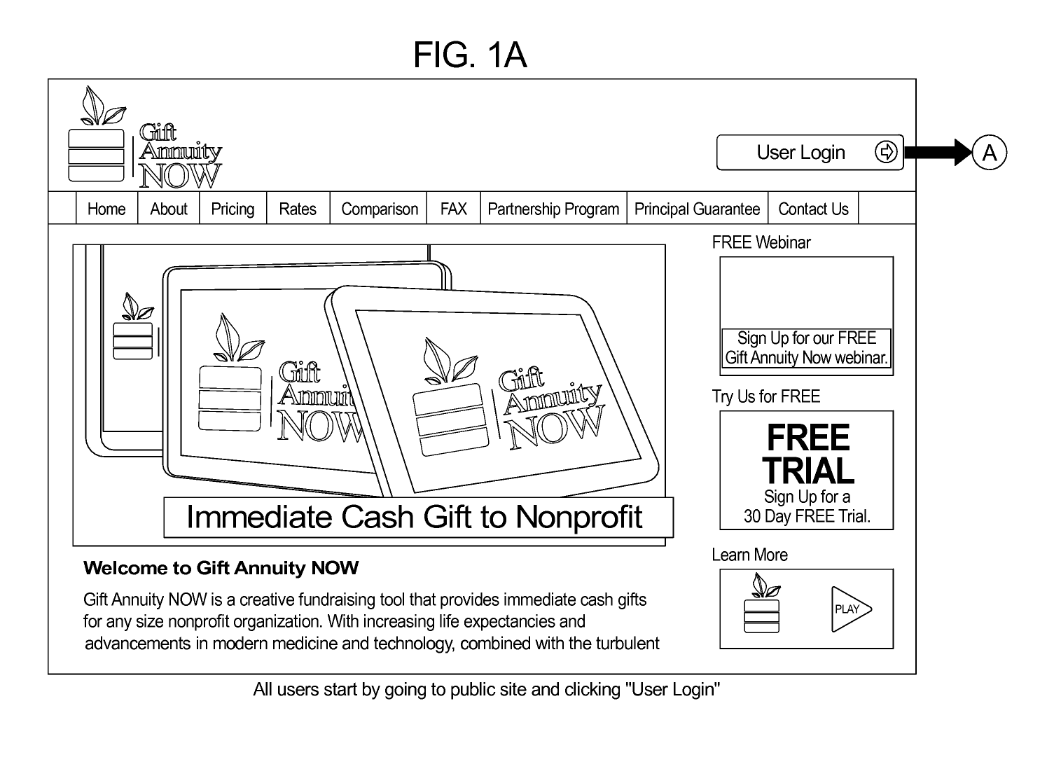

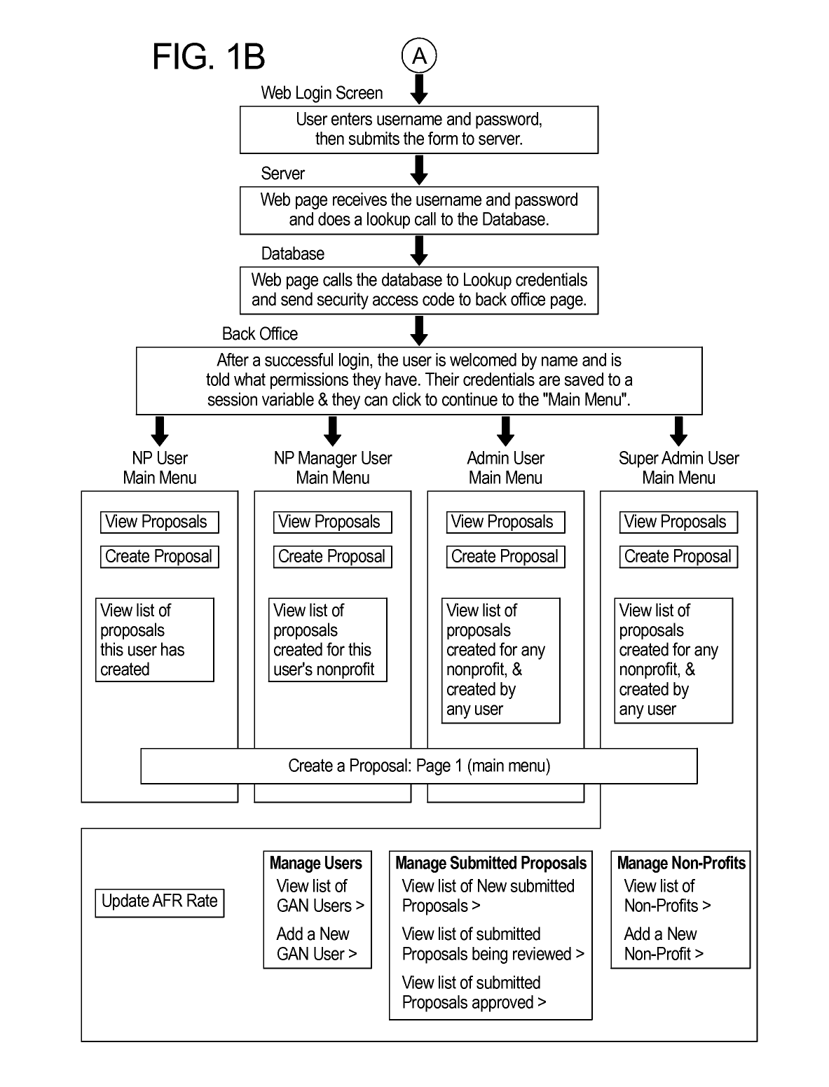

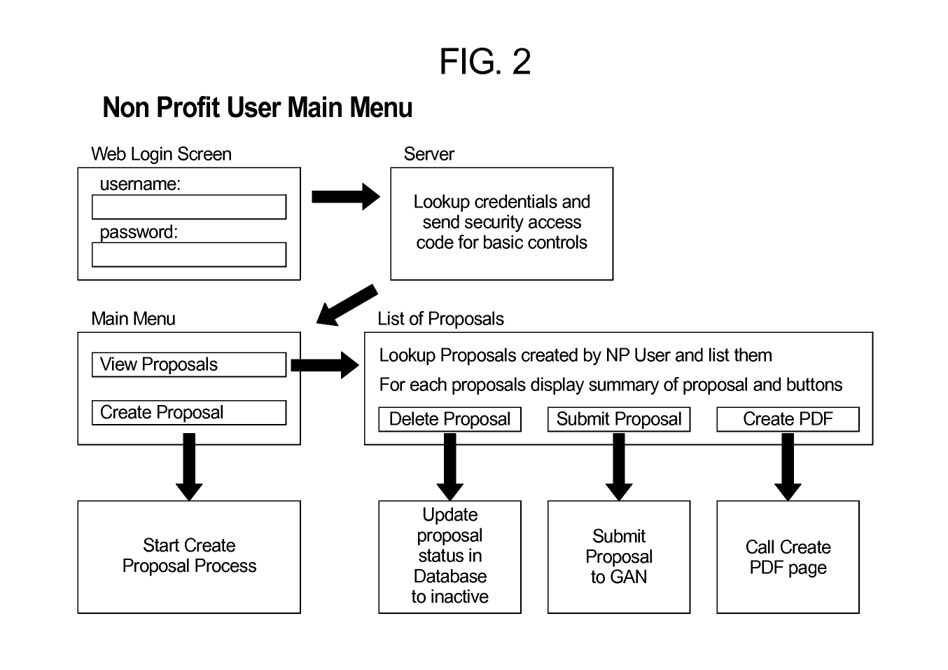

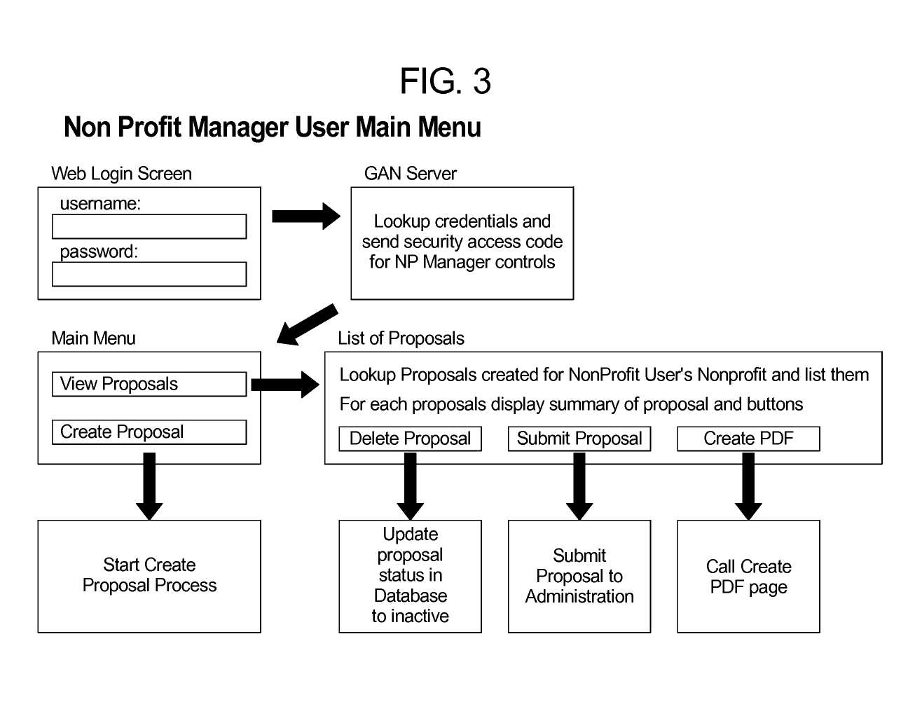

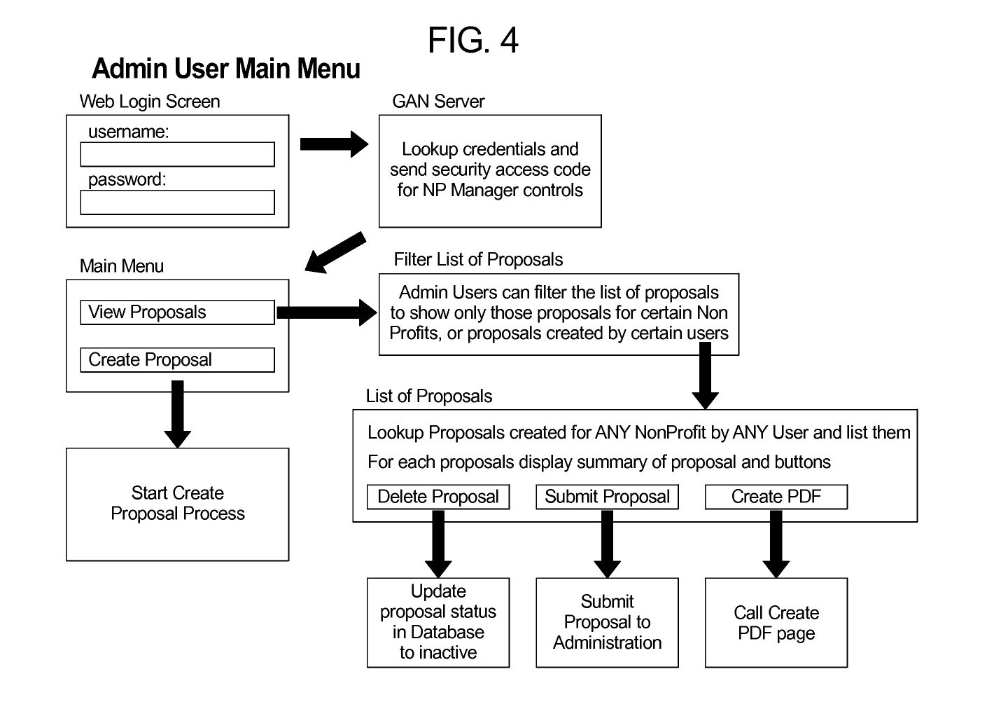

FIG. 1 gives an overview of the method, server and instructions loaded thereon. The instructions installed on the server create an easy-to-read written proposal which compares a plurality of gift annuity products for prospective donors. The instructions also provide means for administrators to manage more “back-office” functions such as user access, editing proposals, tracking proposals and post-proposal customer service.

This proposal is designed to show prospective donors the short and long term advantages of an immediate gift annuity product compared to a traditional gift annuity product. A nonprofit or other authorized user can quickly create such a proposal without any fundraising, investment or financial experience from any Internet-ready computing device. The method is compatible with a desktop, laptop, notebook or mobile computing device using any operating system. This new tool can only increase the amount of fundraising options available to any size nonprofit and the donors who wish to support them. Never before has it been possible for a donor to make an immediate cash gift to a nonprofit, in a single Internet session. It is a win-win for all.

Nonprofits and nonprofit managers most commonly use the method, because they have the most face to face contact with potential donors. However, program administrators and high-level “super” administrators also have authority to create proposals. Program instructions stored on a remote server prompt users to provide, through the Internet, a donor's personal and financial data. The instructions also retrieve information, through the Internet, from a financial data exchange. Using this data, the instructions calculate income and tax consequences of particular gift annuity products. A database elsewhere on the server stores the retrieved and calculated information for future reference.

FIG. 1A shows a user login interface that appears on the screen of an Internet-ready computing device known in the art. Clicking on the “User Login” button prompts the viewer to send a username and password to the server. The server authenticates the user's identity and system privileges based on data previously provided by an administrator.

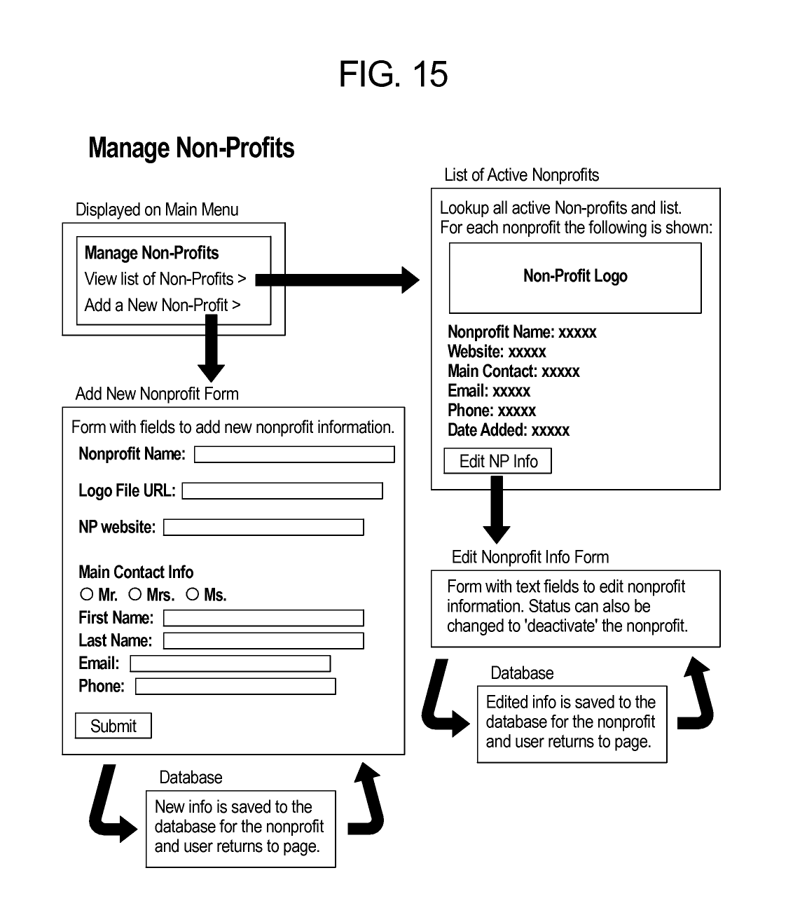

FIG. 1B shows the options available to the user based on his status. All users are permitted to view and create their own proposals. In addition, a nonprofit manager user may view proposals created by any user within his same nonprofit organization. An administrator user can do all of the above, plus view proposals created by any nonprofit organization. A super-administrator can view any proposal for any user, manage user access to the system and manage proposals through the process after they are submitted for processing. FIGS. 15-18 illustrate these back-office functions in more detail.

Managing User Access to Proposal Creation System

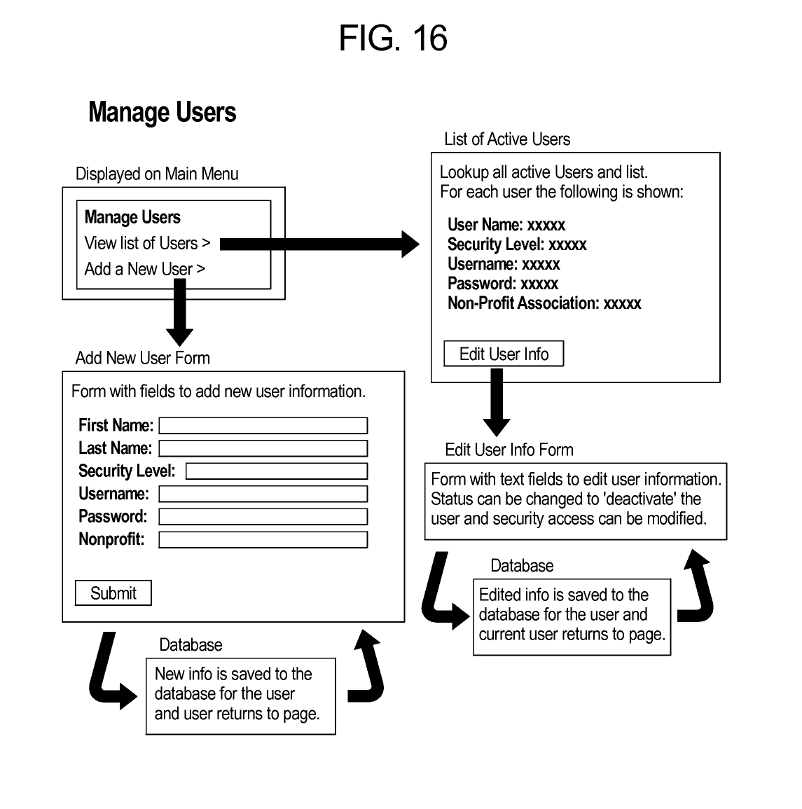

Before a user can create a proposal, he must have access to the system. The instructions stored on the server facilitate, via the Internet, collecting, storing and retrieving user credentials. FIG. 16 shows how a back office super-administrator logs into the system to manage and control user access. Only a super-administrator is allowed to manage user access. Upon login, the instructions prompt the super-administrator to either add a new user or view existing users. To add an existing user, instructions on the server create a web page which collects a first name, last name, security level, password and name of nonprofit, if applicable. Super-administrators have the most privileges, then general system administrators, then nonprofit managers, then general nonprofit users. The super-administrator sends this information to a database on the server, where it is stored. When the new user later tries to log in using his username and password, the instructions authenticate him and direct him to the correct menu.

Any time after a super-administrator creates a new user account, he may view the account. From here, the super-administrator can edit first and last name, security level, username, password and nonprofit name. He may also delete the user account entirely. Any edits are stored in the database.

Managing Nonprofit Contact Information

The instructions also provide means for a back office super-administrator to manage nonprofit contact information for internal customer relations and marketing purposes. As shown on FIG. 15, the super-administrator logs into the system. Instructions on the server create a web page which collects from the super-administrator a nonprofit's name, URL, title, first name, last name, e-mail address and telephone number. The super-administrator clicks a button to submit this information to the server database. This new nonprofit contact information is stored in the database. At any later time, the super-administrator can return to this same page and view, edit or delete existing nonprofit contact information. As with user accounts, any edits are stored in the database. Back office administrators can retrieve this information at any time to follow up with nonprofit users or send them marketing materials.

Input of Government and Professional Association Indices

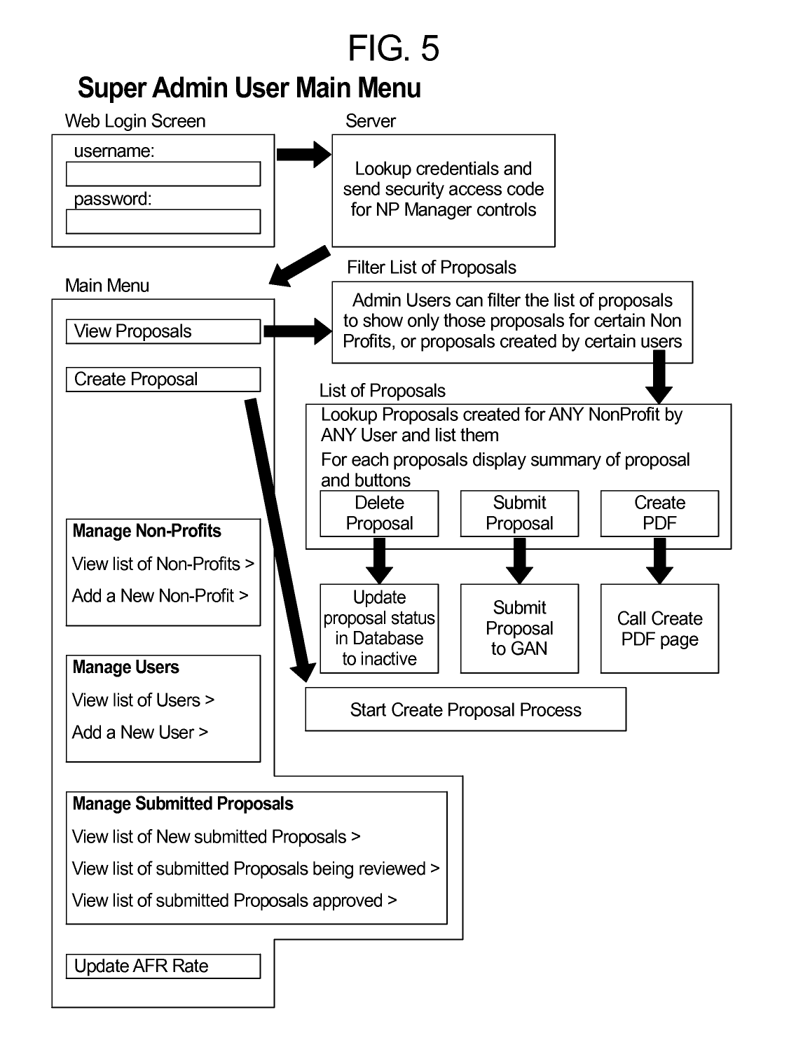

The instructions also provide means for a back office super-administrator to periodically submit financial indices that are used to calculate income and tax consequences of annuity products compared by this system. The first index comes from the Internal Revenue Service. The AFR, published monthly by the IRS, determines the charitable tax deduction for planned gifts such annuities. The rate is the annual rate of return that the IRS assumes the gift assets will earn during the gift term. This is important for the donor to know because the higher the AFR, the greater the tax deduction. The new month's AFR is announced on the 20^{th} day of the preceding month. From his main menu, shown on FIG. 5, the super-administrator has the option to update the AFR.

In addition to the AFR, the super administrator also uploads IRS Publication 1457, Table K, to the database. IRS code section 7520 requires the use of actuarial tables to accurately evaluate annuities. Table K adjusts the value of an annuity based on the prevailing AFR and the frequency at which a donor receives a payout. For example, as of this filing date, for an annuity paid annually at 3.0%, the adjustment factor would be 1.0000. For the same annuity paid quarterly, the adjustment factor would be 1.0112.

The instructions further provide means for a super-administrator to provide the suggested ACGA payout rate table. The ACGA table is stored in the database. The ACGA is a trade association comprised of member charitable organizations. The suggested payout rates are designed to standardize charitable gift giving practices among members. The payout rates are based on a person's mortality, which correlates to his age. A 55 year old donor would therefore be computed at a different rate than someone who is 75. The system uses the applicable ACGA payout rate as a benchmark to compare a traditional to an immediate gift annuity product promoted by this method.

Lastly, the instructions provide means for a super administrator to upload IRS Publication 939 Table V (hereinafter “Table V”). The instructions retrieve certain multipliers found on this table to forecast the estimated percentage of the gift annuity amount needed to guarantee payments.

Creating Proposals

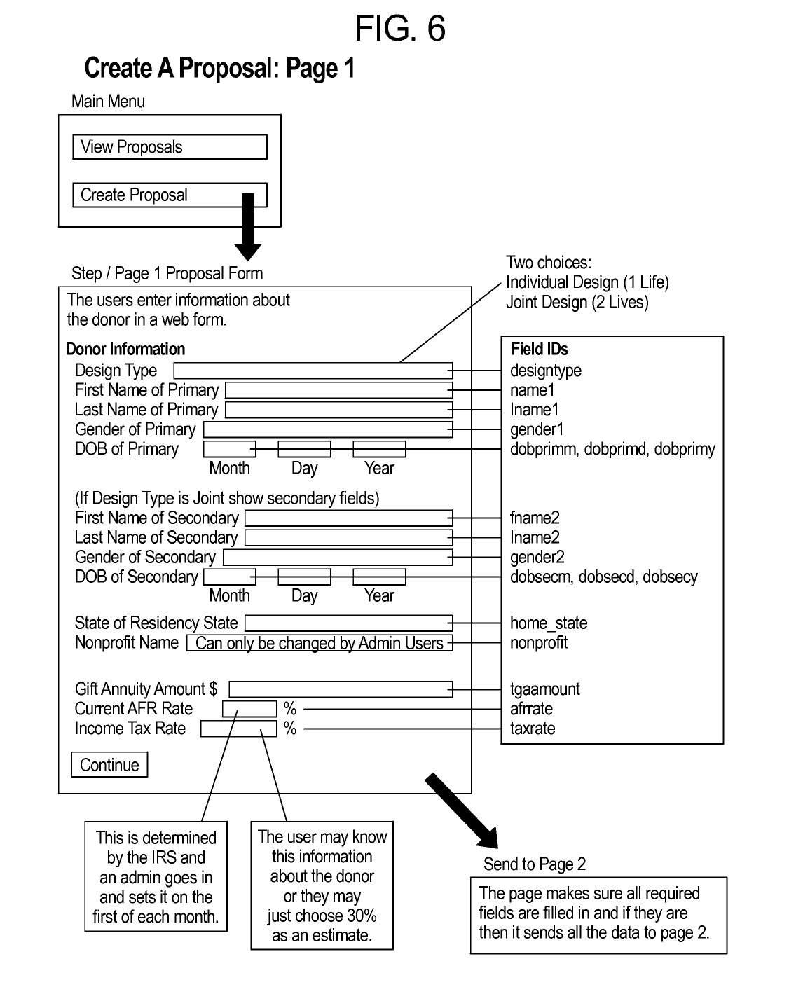

Creating proposals is the lifeblood of the system. Once a user has been granted access to the system, he may create a proposal. Via the Internet, the server instructions coordinate and drive this entire process. All users, even back office administrators who are not affiliated with a nonprofit organization, may create proposals. All users create proposals using the same method. The steps involved in creating a proposal are shown on FIGS. 6-14.

Instructions installed on the server create a web page prompting a remote user to log in. The page calls the server database to verify the user's credentials. Once authenticated, the instructions take the user to his security level's main menu. All main menus have an option to create a proposal.

The purpose of this first proposal page is to gather the information necessary to calculate the income and tax consequences of a traditional gift annuity product. To do this, the first page collects from the user the following financial and biographical information about a prospective donor: annuity design type, first name, last name, gender, date of birth, state of residency, the amount of gift annuity the donor wants to give and the donor's income tax rate. The user typically knows the applicable tax rate, or otherwise can ask the donor.

As for annuity design, the donor can choose between individual or joint design. If he elects a joint design, the user can provide the first name, last name, gender and date of birth of a second, or joint, donor. The instructions assign variable names to each of these data points and store them in a table in the database. Please see FIG. 6. The instructions then send this information to one of two second proposal form pages, depending on whether an individual or joint annuity design is chosen.

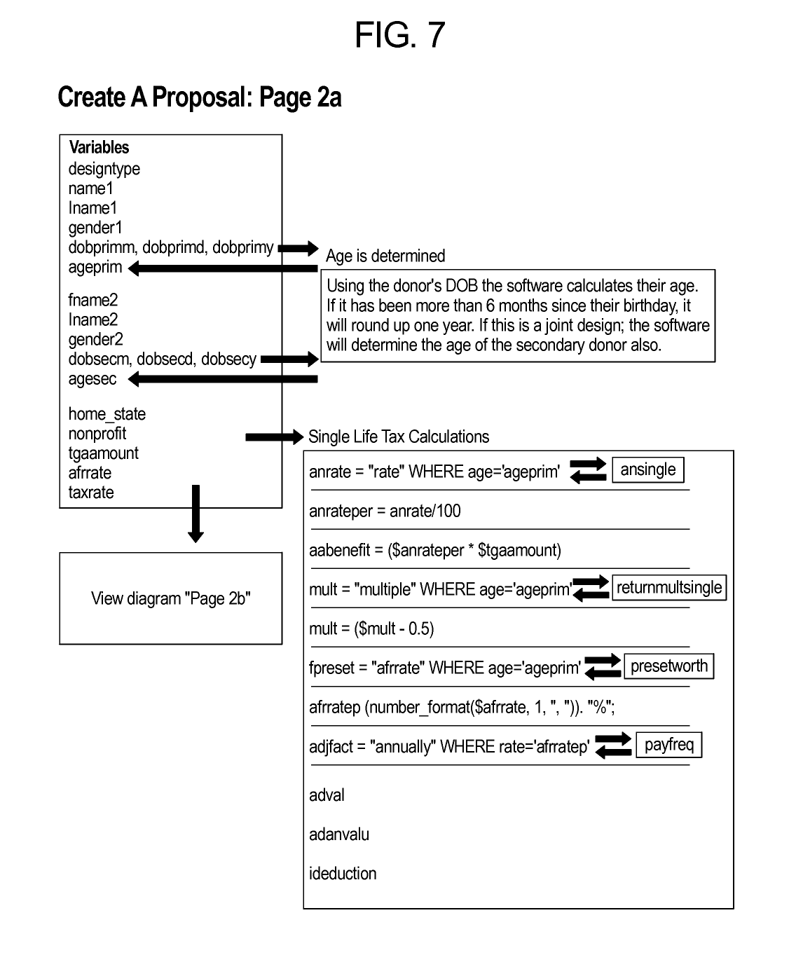

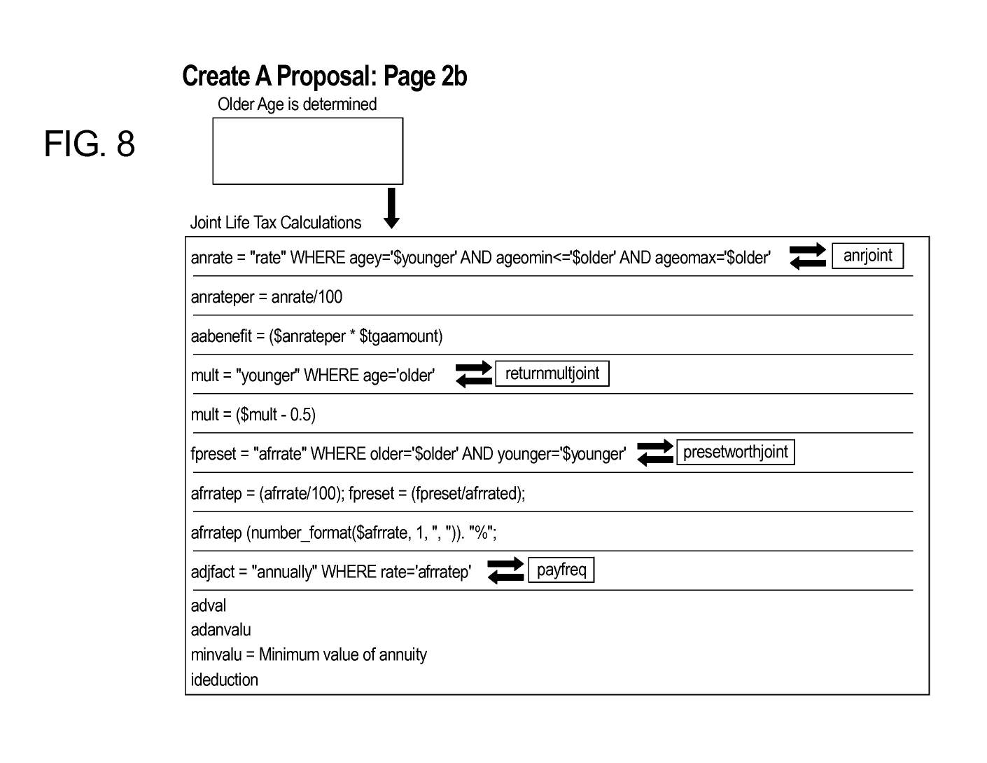

For an individual design, the first page sends the above biographical data to the page shown at FIG. 7. If a joint design is chosen, the first page sends this data to the page shown at FIG. 8. For both individual and joint designs, the instructions use the input date of birth for either an individual donor or for joint donors to calculate the donor(s) age(s), rounded to the nearest whole year. The instructions then create a new variable representing the donor(s) age(s). This information is stored among four tables in the database designated for receiving donor biographical and financial information.

For an individual design, the instructions then use the single donor's age, desired gift annuity amount, applicable ACGA rate, AFR, multiplier and IRS adjustment factor to calculate taxable income, tax-free income, tax deduction, tax savings and tax exclusion ratio. Please see FIG. 7. In order, the instructions do the following: The names within parentheses represent variable names assigned to these numbers.

Calculate the primary donor's age ($ageprim) and use that to call the database and locate the applicable ACGA annuity rate ($anrate) from the ACGA table the super administrator previously uploaded.

Convert the AFR to a decimal ($anrateper) in this way: $anrate/100, then

Calculate the annual annuity benefit ($aabenefit) in this way: $anrateper*$tgaamount, then

Call the database to identify and retrieve the IRS Publication 939 Table V multiplier ($mult) corresponding to the donor's age. Subtract 0.5 from $mult, then

Call the database again to identify the AFR which correlates to the donor's age ($fpreset), then

Format $fpreset to be expressed in a percentage, then

Call the database yet again to locate the applicable IRS Publication 1457 Table K adjustment factor ($adjfact) for this AFR and frequency of payment. In this invention, the frequency is always annual, then

Estimate the amount needed to fund the annuity payment ($adanvalu) in this way: ($adjfact)*($fpreset)*($aabenefit), then

Calculate the income tax deduction ($ideduction) in this way: $tgaamount−$adanvalu, then

Calculate the amount of tax-free income ($taxfreeincome) in this way: $aabenefit*($adanvalu/$aabenefit*$mult)), then

Calculate the amount of taxable income ($taxableincome) in this way: $aabenefit−$taxfreeincome.

For joint life tax calculations, the instructions perform the same sequence of instructions and calculations as for single life, with one exception. For a joint life design, the instructions determine which donor is older and which is younger. This has important consequences for the proposal, as the ACGA rate depends on each donor's age. The primary donor is designated $ageprim, regardless of age; the secondary donor is designated $agesec. The instructions call the database to determine each donor's applicable ACGA rate, then perform the same series of calculations as immediately above, using the same variable names, one for each donor.

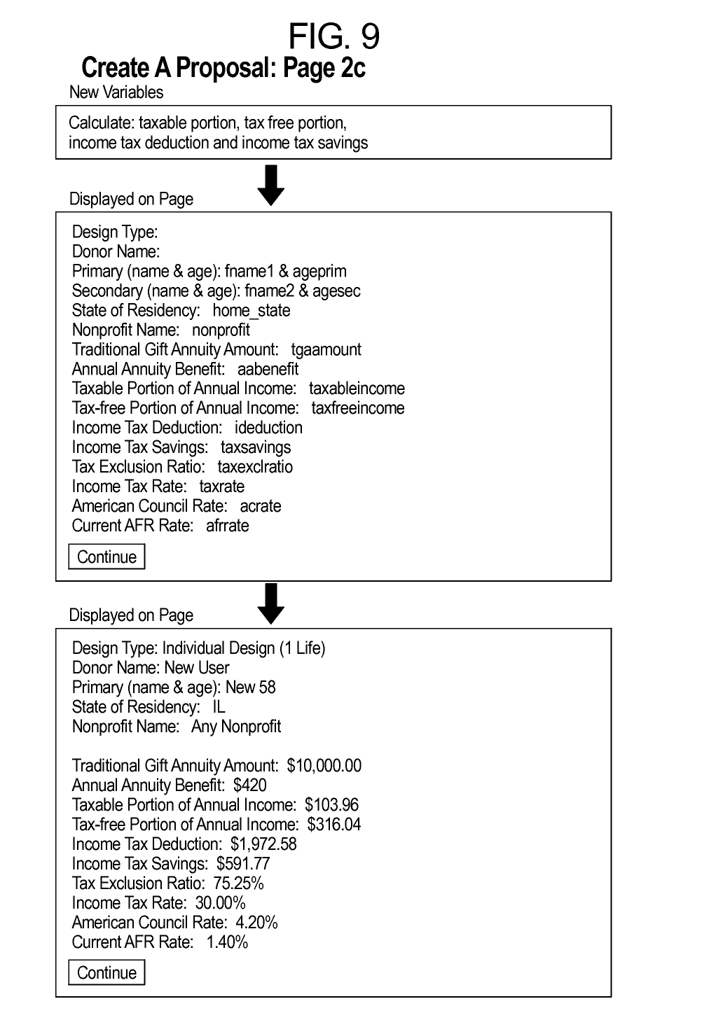

At this point, the instructions display for the user a preview of the income and tax consequences of a traditional gift annuity product. This provides the baseline against which the donor can compare the two novel immediate gift annuity products. FIG. 9 shows an example of a traditional gift annuity for a user born in 1955, residing in Illinois and having $10,000 to give. The user clicks “continue” to proceed to a third proposal form page. The third proposal page will retrieve and generate information about a second gift annuity product, an immediate gift annuity without principal guarantee.

At this third proposal page, the instructions retrieve from the database all of the information supplied or calculated from the previous two pages: design type, first name, last name, gender, date of birth (month/day/year) and age, state of residency, name of the intended nonprofit, gift annuity amount, AFR, amount of tax free income, amount of tax savings, tax exclusion ratio and ACGA rate. For joint design, the instructions pull the first name, last name, gender, date of birth and age of the second donor.

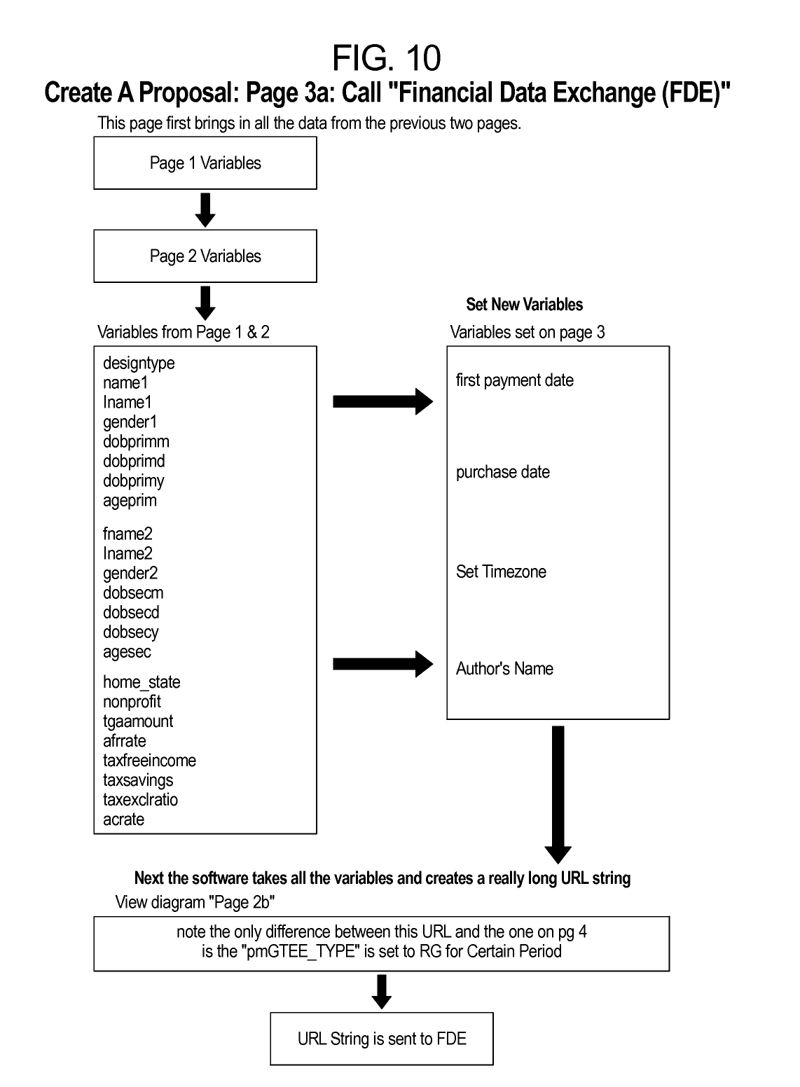

Using this information, the instructions set four new variables. “Purchase date” is by default the present day, month and year. “Payment date” is the purchase date plus one year. The time zone is set to Eastern Standard Time. The author of the proposal is set by default to the current user. Please see FIG. 10.

The instructions next call the website of a Financial Data Exchange service (FDE). The FDE surveys the markets of a variety of financial products and determines real-time payout, tax consequences and industry ratings. The back office subscribes to this service to allow all of its users access to the information it provides. In this invention, the instructions request the FDE to retrieve market data for providers of SPIA. At this stage, the instructions specify a SPIA without a principal guarantee option.

The instructions do this by creating URL string, which includes the purchase date, payment date, time zone, author data set on the third proposal page, plus these variables set on the first two proposal pages: donor date(s) of birth, gender(s), state of residency, gift annuity amount and purchase date. The instructions send this URL string to the FDE.

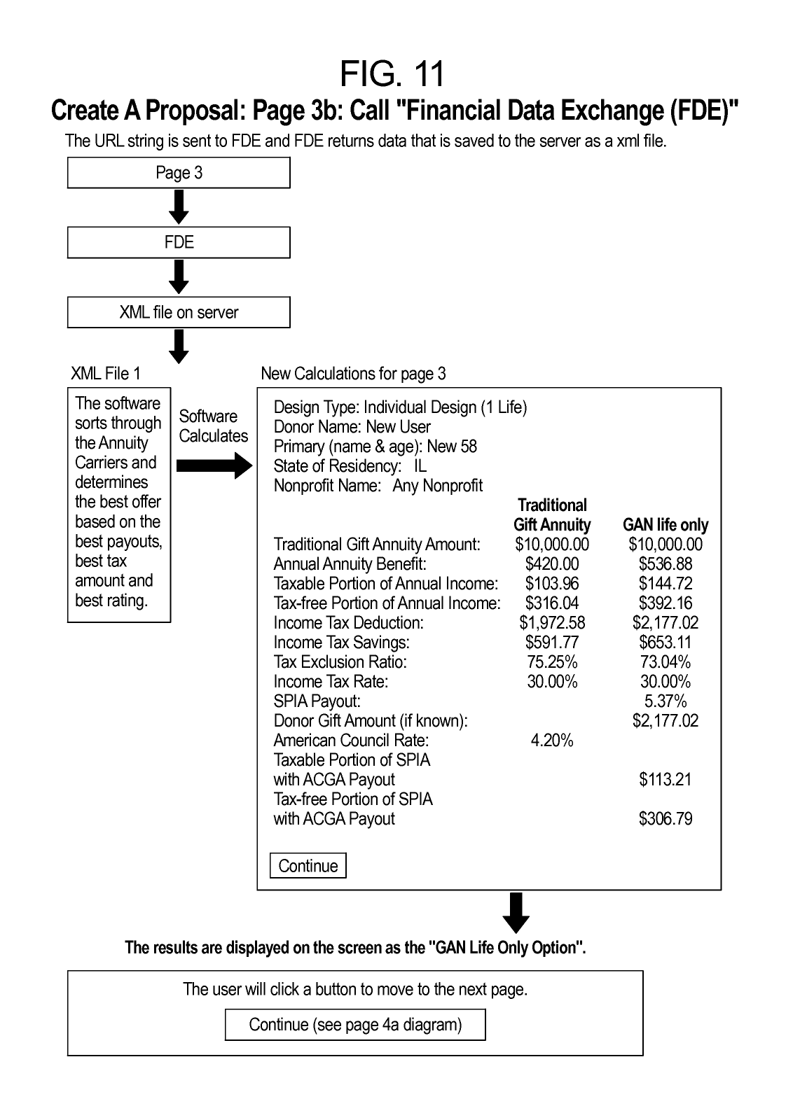

The FDE, in turn, uses this information to match the donor with a plurality of possible annuity placement firms. The FDE sends this information to the server in the form of an XML file. This XML file is stored on the database. The instructions first filter this XML file for providers having an A.M. Best minimum rating of A or A+. A.M. Best ratings grade annuity placement firms on their strength, amount of assets, outlook and credit ratings. The instructions rank the remaining annuity providers in order of payout and tax. The instructions then identify that one annuity provider which has a minimum of an A rating, offering the highest payout ($aabenefitlife) and lowest tax ($taxableincomelife) for this particular donor(s) age, intended gift amount and state of residency. Please see FIG. 11.

The instructions use the information retrieved from the FDE to calculate for this SPIA, life only option: tax-free portion of annual income, SPIA payout, donor gift amount, income tax deduction, income tax savings, taxable portion of SPIA with ACGA payout and tax-free portion of SPIA with ACGA Payout. Specifically, the instructions:

Calculate the tax-free portion of annual income ($taxfreeincomelife) in this way: $aabenefitlife−$taxableincomelife, then

Calculate the tax exclusion ratio ($taxexclratiolife) in this way: (1−(taxableincomelife/$aabenefitlife)), then

Calculate the SPIA payout ($spiapay) in this way: ($aabenefitlife/$tgaamount), then

Calculate Donor Gift Amount ($donorgift) in this way: ($tgaamount−($aabenefit/$spiapay)), then

Let the income tax deduction ($ideductionlife) equal $donorgift, then

Calculate income tax savings ($taxsavingslife) in this way: ($ideductionlife*($taxrate/100)), then

Calculate the taxable portion of the SPIA with ACGA Payout ($taxspia) in this way: (($taxableincomelife/$aabenefitlife)*$aabenefit); then

Calculate the tax-free portion of the SPIA with ACGA Payout ($taxfreespia) in this way: ($aabenefit−$taxspia).

The instructions use these calculations to create a now two-part table comparing the features of a traditional gift annuity to those of an immediate gift annuity, life only. The instructions display this table on the user's Internet-ready device. The user clicks “continue” to proceed to a fourth proposal creation page.

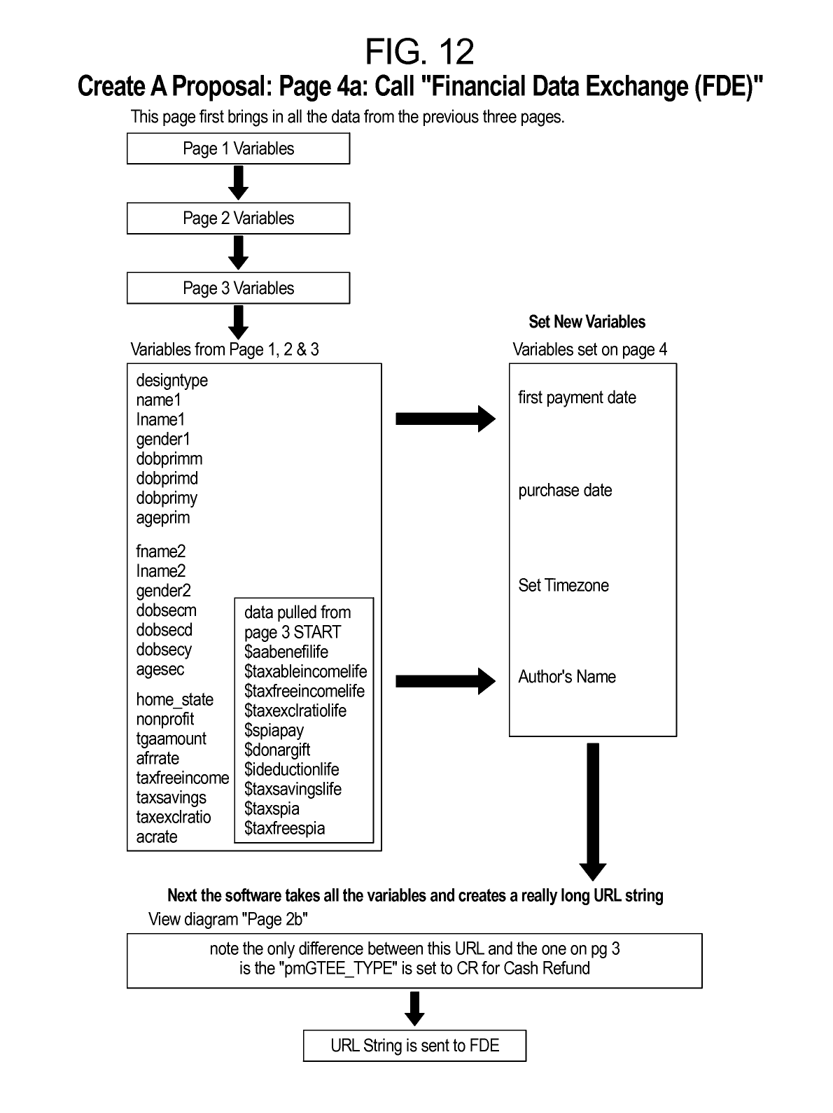

The fourth page will retrieve and generate information about a third and final gift annuity product, an immediate gift annuity with principal guarantee option. At the fourth page, the instructions retrieve from the database all of the information supplied or calculated from the previous three pages. Using this information, the instructions set four new variables. “Purchase date” is by default the present day, month and year. “Payment date” is the purchase date plus one year. The time zone is set to Eastern Standard Time. The author of the proposal is set by default to the current user. Please see FIG. 12.

The instructions again call the same FDE website. During this second call, the instructions request the FDE to retrieve market data for providers of SPIA, this time looking for providers specifically offering a principal guarantee option.

The instructions again create a URL string, which includes the purchase date, payment date, time zone, author data set on the fourth proposal page, plus these variables set on the first two proposal pages: donor date(s) of birth, gender(s), state of residency, gift annuity amount and purchase date. The instructions send this second URL string to the FDE.

The FDE again uses this information to match the donor with a plurality of possible providers of a SPIA with principal guarantee. The FDE sends this information to the server in the form of a second XML file. This second XML file is stored in the database.

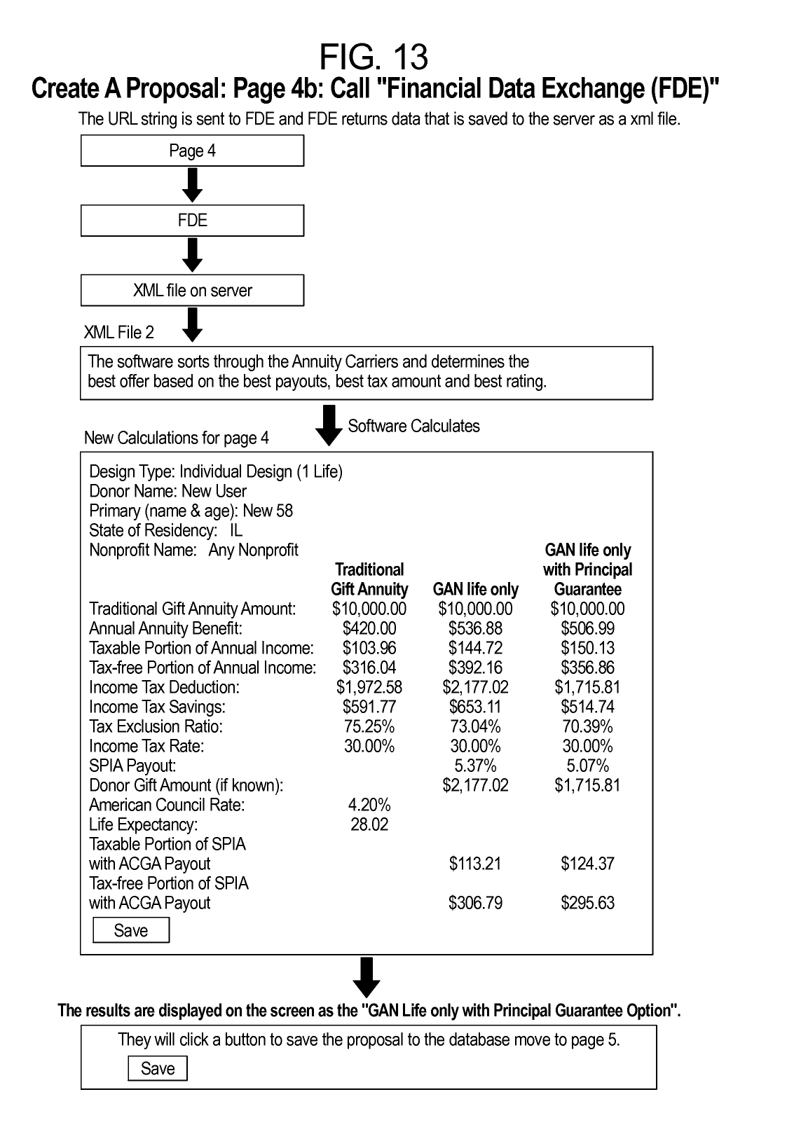

The instructions filter this second XML file for providers having an A.M. Best minimum rating of A or A+. As above, the instructions rank the remaining annuity providers in order of payout and tax. The instructions then identify that one annuity provider with a minimum A rating, offering the highest payout ($aabenefitlifecash), lowest tax ($taxableincomelifecash) and highest A.M. Best industry rating for this particular donor. Please see FIG. 13.

The instructions then use the information retrieved from the FDE to calculate for this particular product: tax-free portion of annual income, SPIA payout, donor gift amount, income tax deduction, income tax savings, taxable portion of SPIA with ACGA payout, tax-free portion of SPIA with ACGA payout, and additionally, life expectancy cash. Specifically, the instructions:

Calculate the Tax-free Portion of Annual Income ($taxfreeincomelifecash) in this way: $aabenefitlifecash−$taxableincomelifecash), then

Calculate the Tax Exclusion Ratio ($taxexclratiolifecash) in this way: (1−$taxableincomelifecash/$aabenefitlifecash)), then

Calculate the SPIA payout ($spiapaycash) in this way: ($aabenefitlifecash/$tgaamount), then

Calculate the Donor Gift Amount ($donorgiftcash) in this way: ($tgaamount−($aabenefit/$spiapaycash)), then

Let the Income Tax Deduction ($ideductionlifecash)=$donorgiftcash, then

Calculate the Income Tax Savings ($taxsavingslifecash) in this way: ($ideductionlifecash*($taxrate/100)), then

Calculate the Taxable Portion of SPIA with ACGA Payout ($taxspiacash) in this way: (($taxableincomelifecash/$aabenefitlifecash)*$aabenefit), then

Calculate the Tax-Free Portion of SPIA with ACGA Payout ($taxfreespiacash) in this way: ($aabenefit−$taxspiacash), then

Calculate the Life Expectancy Cash ($lifeexp) in this way: ($tgaamount/$taxfreeincomelifecash).

The instructions next display a now three-column preview comparing the features of a traditional gift annuity to those of an immediate gift annuity, without principal guarantee, and also to an immediate gift annuity with principal guarantee. Please see FIG. 13. The user previews the table. Then he clicks “save” to store the proposal in the database and proceed to the fifth and final proposal creation page.

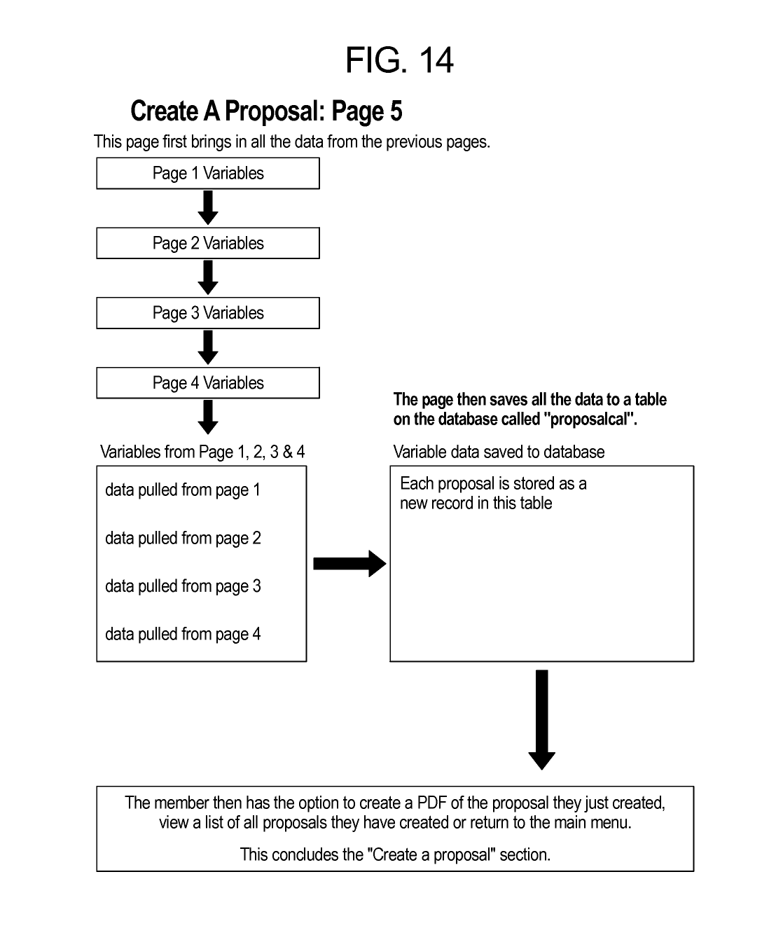

At the fifth page, the instructions retrieve all of the data supplied and calculated from the previous four pages. The instructions organize and consolidate this information into a new record, which is stored in a dedicated proposal table in the database. Please see FIG. 14. Once a new proposal has been stored, the user has the option of generating a full-color PDF copy, reviewing the proposal or returning to his main menu. The newly stored proposal also becomes available for manager nonprofit users, administrators or super-administrators to view, edit or delete.

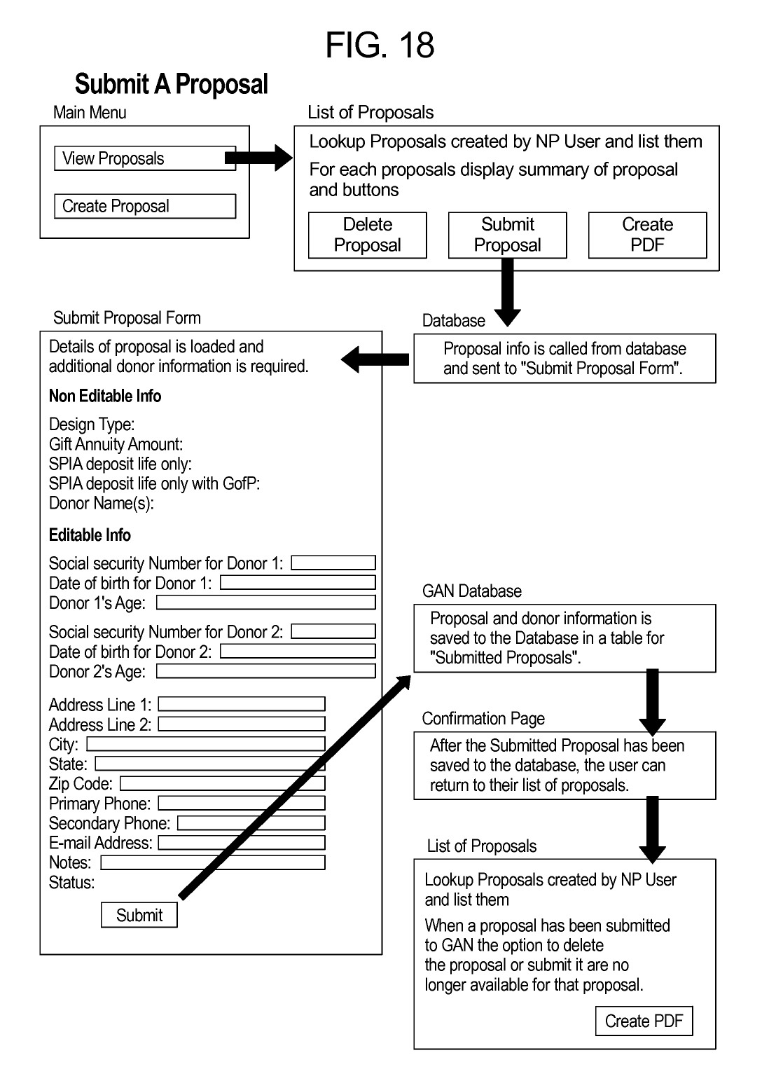

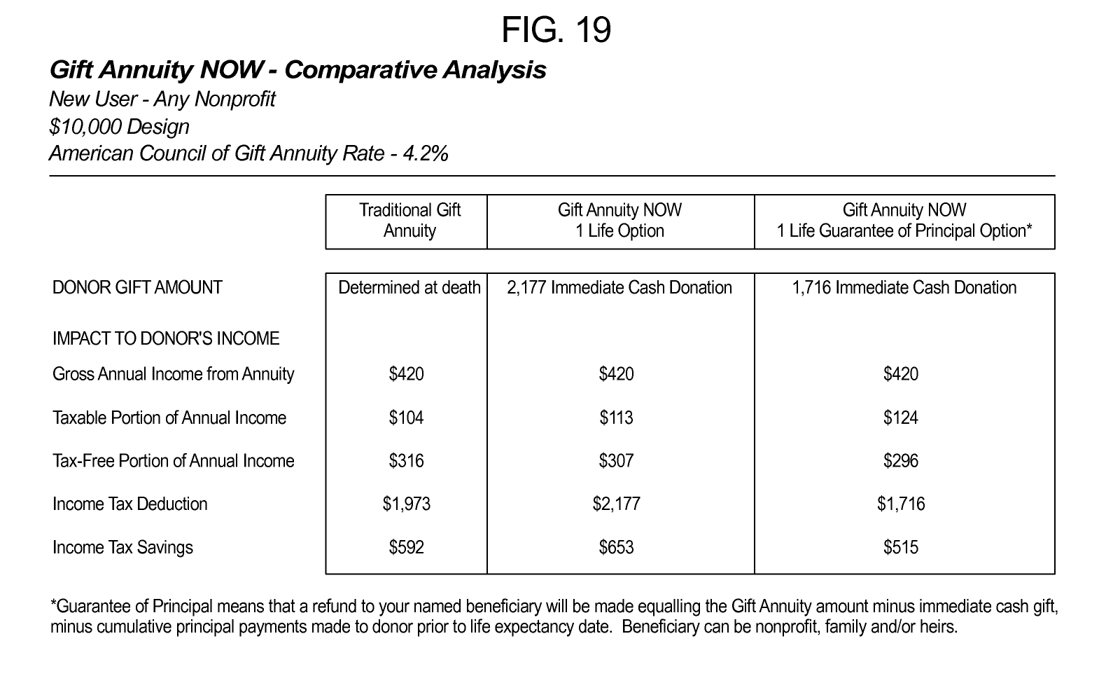

The PDF copy of the proposal includes background and marketing information that does not appear on the preview screens. It is suitable for presenting a prospective donor the advantages of an immediate gift annuity product. The user may either print a hard copy or e-mail the PDF to the donor. If the donor agrees to the terms of the proposal, the user returns to his main menu and prepares the proposal for final submission to the back office. Please see FIG. 18.

Submitting Proposals

Once a donor has accepted a proposal, the instructions provide means for him to edit and confirm the terms before submitting to the back office. From the main menu, the user selects “view proposals,” identifies the proposal he wants to submit and clicks “submit proposal.” The instructions then retrieve this particular proposal data from the database and display it on the screen of his Internet-ready computing device. Some of the data is fixed, such as design type, total gift annuity amount, immediate cash gift amount and donor name. Other data can be edited, such as donor(s) social security number(s), date(s) of birth, age(s), address, city, state, zip code, phone numbers, and e-mail address. The instructions provide a form for the user to make these edits. The form also includes a space for the user to write miscellaneous notes. Once the user is satisfied with the final proposal terms, he clicks “submit.” Submitting a proposal to the back office is final. The user is no longer able to edit or delete the proposal. The instructions store the final proposal in the database in a separate table specifically designated for submitted proposals.

Post-Submission Processing

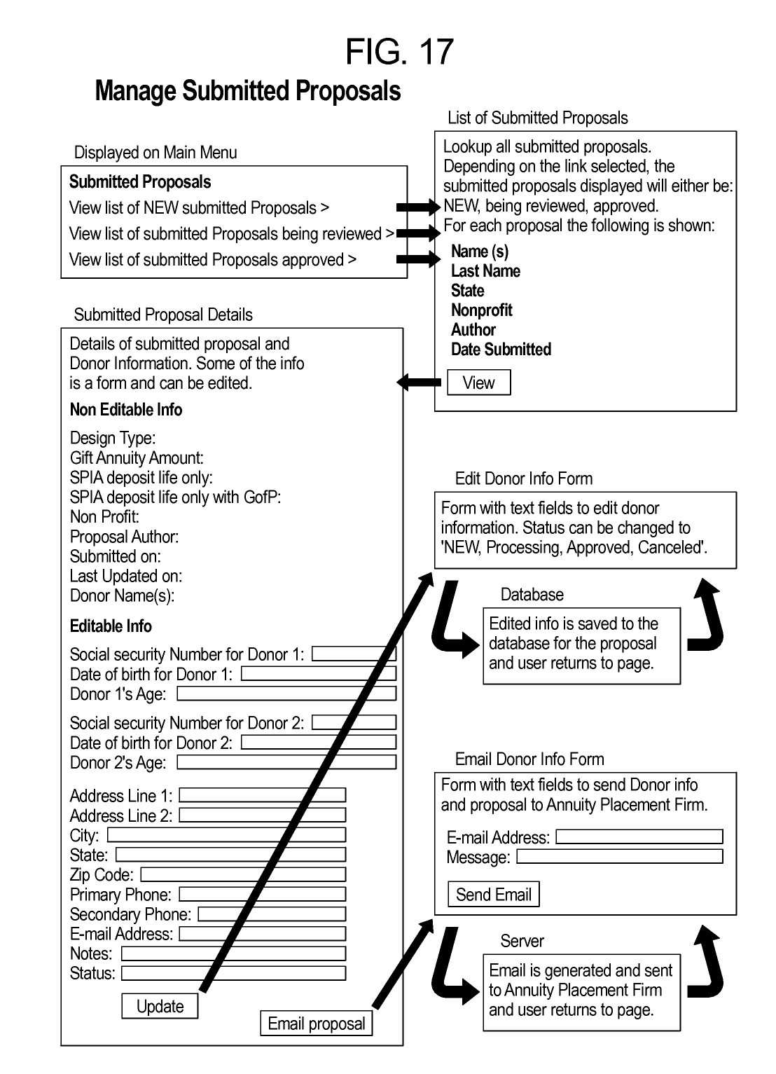

After a user submits a final proposal to the back office, administrators prepare it for delivery to the selected annuity placement firm. To do this, an administrator selects the “manage submitted proposals” menu shown as FIG. 17. The program instructions provide a form for an administrator to further edit a donor′(s) social security number(s), date(s) of birth, age(s), address, city, state, zip code, phone numbers, and e-mail address. The instructions also provide space for the administrator to write notes and to indicate the status of the proposal. The status of the proposal is chosen from among: new, processing, approved or cancelled. The instructions store the contents of this form in the database table designated for submitted proposals.

Elsewhere on this menu, the instructions provide means for the administrator to e-mail the proposal and donor information to the annuity placement firm. The annuity placement firm assumes control and management of the contract from this point forward.

I claim:

1. A server having a non-transitory computer program installed thereon for creating proposals comparing a plurality of gift annuity products, comprising instructions for:
a. Authenticating administrator and end user access to the server;
b. Collecting, storing and retrieving, from a database, end user contact information;
c. Collecting, storing and retrieving, from a database, a government financial index;
d. Collecting, storing and retrieving, from a database, a professional association financial index;
e. Collecting, storing and retrieving, from a database, biographical information and financial information of a prospective donor;
f. Using the government financial index, professional association financial index, end user biographical information and end user financial information to calculate the income and tax consequences of a first gift annuity product;
g. Displaying to an end user the income and tax consequences of a first gift annuity product;
h. Retrieving a first set of annuity carrier information from a financial data exchange;
i. Using the first set of annuity carrier information to calculate the income and tax consequences of a second gift annuity product;
j. Displaying to the end user the income and tax consequences of the first and the second gift annuity products;
k. Retrieving a second set of annuity carrier information from the financial data exchange;
l. Using the second set of annuity carrier information to calculate the income and tax consequences of a third gift annuity product;
m. Displaying to the end user the income and tax consequences of the first, second and third gift annuity products;
n. Generating a proposal comparing the income and tax consequences of all three gift annuity products;
o. Storing, editing, deleting and retrieving the proposal; and
p. Submitting the proposal to a central administrator on behalf of the prospective donor.

2. The server as in claim 1, wherein the government financial index is the Internal Revenue Service Applicable Federal Rate (AFR) and the professional association financial index is the American Council of Gift Annuities (ACGA) payout rate.

3. The server as in claim 1, wherein the prospective donor biographical information comprises first name, last name, gender, date of birth, and state of residency, and the prospective donor financial information comprises gift annuity amount ($tgaamount) and income tax rate.

4. The server as in claim 3, wherein using the government financial index, professional association financial index, end user biographical information and end user financial information income and tax consequences comprises:
a. Calculating a donor's age ($ageprim), then
b. Retrieving from the database an ACGA payout rate ($anrate) corresponding to the donor's age, then
c. Converting the AFR to a decimal ($anrateper) in this way: $anrate/100, then
d. Calculating the annual annuity benefit ($aabenefit) in this way: $anrateper*$tgaamount, then
e. Retrieving from the database the IRS Publication 939 Table V multiplier ($mult) corresponding to the donor's age, then
f. Subtracting 0.5 from $mult, then
g. Calling the database again to identify the AFR which correlates to the donor's age ($fpreset), then
h. Formatting $fpreset to be expressed in a percentage, then
i. Retrieving from the database the IRS Publication 1457 Table K adjustment factor ($adjfact) for the applicable AFR and a frequency of payment, then
j. Estimating the amount needed to fund the annuity payment ($adanvalu) in this way: ($adjfact)*($fpreset)*($aabenefit), then
k. Calculating the income tax deduction ($ideduction) in this way: $tgaamount −$adanvalu, then
l. Calculating the amount of tax-free income ($taxfreeincome) in this way: $aabenefit*($adanvalu/$aabenefit*$mult)), then
m. Calculating the amount of taxable income ($taxableincome) in this way: $aabenefit −$taxfreeincome.

5. The server as in claim 4, wherein the first annuity product comprises a traditional gift annuity.

6. The server as in claim 1, wherein using the first set of annuity carrier information comprises:
a. Retrieving from the database a highest payout ($aabenefitlife) and a lowest tax ($taxableincomelife) of an annuity carrier, then
b. Calculating a tax-free portion of annual income ($taxfreeincomelife) in this way: $aabenefitlife−$taxableincomelife, then
c. Calculating a tax exclusion ratio ($taxexclratiolife) in this way: (1−(taxableincomelife/$aabenefitlife)), then
d. Calculating a SPIA payout ($spiapay) in this way: ($aabenefitlife/$tgaamount), then
e. Calculating a donor gift amount ($donorgift) in this way: ($tgaamount−($aabenefit/$spiapay)), then
f. Letting an income tax deduction ($ideductionlife) equal $donorgift, then
g. Calculating an income tax savings ($taxsavingslife) in this way: ($ideductionlife*($taxrate/100)), then
h. Calculating a taxable portion of a SPIA with ACGA Payout ($taxspia) in this way: (($taxableincomelife/$aabenefitlife)*$aabenefit), then
i. Calculating a tax-free portion of a SPIA with ACGA Payout ($taxfreespia) in this way: ($aabenefit−$taxspia).

7. The server as in claim 6, wherein the second annuity product comprises an immediate gift annuity for life only, without principal guarantee.

8. The server as in claim 1, wherein using the second set of annuity carrier information comprises:
a. Retrieving from the database a highest payout ($aabenefitlifecash) and a lowest tax ($taxableincomelifecash, then
b. Calculating a tax-free portion of annual income ($taxfreeincomelifecash) in this way: $aabenefitlifecash−$taxableincomelifecash), then
c. Calculating a tax exclusion ratio ($taxexclratiolifecash) in this way: (1−$taxableincomelifecash/$aabenefitlifecash)), then
d. Calculating a SPIA payout ($spiapaycash) in this way: ($aabenefitlifecash/$tgaamount), then
e. Calculating a donor gift amount ($donorgiftcash) in this way: ($tgaamount−($aabenefit/$spiapaycash)), then
f. Letting an income tax deduction ($ideductionlifecash)=$donorgiftcash, then
g. Calculating an income tax savings ($taxsavingslifecash) in this way: ($ideductionlifecash*($taxrate/100)), then
h. Calculating a taxable portion of a SPIA with ACGA Payout ($taxspiacash) in this way: (($taxableincomelifecash/$aabenefitlifecash)*$aabenefit), then
i. Calculating a tax-free portion of a SPIA with ACGA Payout ($taxfreespiacash) in this way: ($aabenefit−$taxspiacash), then
j. Calculating a life expectancy cash ($lifeexp) in this way: ($tgaamount/$taxfreeincomelifecash).

9. The server as in claim 8, wherein the third annuity product comprises an immediate gift annuity with principal guarantee.

10. The server as in claim 1, wherein the database stores: end user authentication credentials, end user contact information, the government financial index, the professional association financial index, biographical information of the prospective donor, financial information of the prospective donor, and proposals.

11. A computer-implemented method for creating proposals comparing a plurality of gift annuity products, comprising:
a. Authenticating, by a computer processor, via a network, administrator and end user access to the server;
b. Collecting, storing and retrieving, by the computer processor, via the network, end user contact information;
c. Collecting, storing and retrieving, by the computer processor, via the network, a government financial index;
d. Collecting, storing and retrieving, by the computer processor, via the network, a professional association financial index;
e. Collecting, storing and retrieving, by the computer processor, via the network, biographical information and financial information of a prospective donor;
f. Using, by the computer processor, the government financial index, professional association financial index, end user biographical information and end user financial information to calculate the income and tax consequences of a first gift annuity product;
g. Displaying, by the computer processor, via the network, to an end user the income and tax consequences of a first gift annuity product;
h. Retrieving, by the computer processor, via the network, a first set of annuity carrier information from a financial data exchange;
i. Using, by the computer processor, the first set of annuity carrier information to calculate the income and tax consequences of a second gift annuity product;
j. Displaying, by the computer processor, via the network, to the end user the income and tax consequences of the first and the second gift annuity products;
k. Retrieving, by the computer processor, via the network, a second set of annuity carrier information from the financial data exchange;
l. Using, by the computer processor, via the network, the second set of annuity carrier information to calculate the income and tax consequences of a third gift annuity product;
m. Displaying, by the computer processor, via the network, to the end user the income and tax consequences of the first, second and third gift annuity products;
n. Generating, by the computer processor, a proposal comparing the income and tax consequences of all three gift annuity products;
o. Storing, editing, deleting and retrieving, by the computer processor, via the network, the proposal; and
p. Submitting, by the computer processor, via the network, the proposal to a central administrator on behalf of the prospective donor.

12. The method of claim 11, wherein the government financial index is the Internal Revenue Service Applicable Federal Rate and the professional association financial index is the American Council of Gift Annuities payout rate.

13. The method of claim 11, wherein the prospective donor biographical information comprises first name, last name, gender, date of birth, and state of residency, and the prospective donor financial information comprises gift annuity amount ($tgaamount) and income tax rate.

14. The method of claim 13, wherein using the government financial index, professional association financial index, end user biographical information and end user financial information comprises:
a. Calculating a donor's age ($ageprim), then
b. Retrieving from the database an ACGA payout rate ($anrate) corresponding to the donor's age, then
c. Converting the AFR to a decimal ($anrateper) in this way: $anrate/100, then
d. Calculating the annual annuity benefit ($aabenefit) in this way: $anrateper*$tgaamount, then
e. Retrieving from the database the IRS Publication 939 Table V multiplier ($mult) corresponding to the donor's age, then
f. Subtracting 0.5 from $mult, then
g. Calling the database again to identify the AFR which correlates to the donor's age ($fpreset), then
h. Formatting $fpreset to be expressed in a percentage, then
i. Retrieving from the database the IRS Publication 1457 Table K adjustment factor ($adjfact) for the applicable AFR and a frequency of payment, then
j. Estimating the amount needed to fund the annuity payment ($adanvalu) in this way: ($adjfact)*($fpreset)*($aabenefit), then
k. Calculating the income tax deduction ($ideduction) in this way: $tgaamount −$adanvalu, then
l. Calculating the amount of tax-free income ($taxfreeincome) in this way: $aabenefit*($adanvalu/$aabenefit*$mult)), then
m. Calculating the amount of taxable income ($taxableincome) in this way: $aabenefit −$taxfreeincome.

15. The method of claim 14, wherein the first annuity product comprises a traditional gift annuity.

16. The method of claim 11, wherein using the first set of annuity carrier information comprises:
a. Retrieving from the database a highest payout ($aabenefitlife) and a lowest tax ($taxableincomelife) of an annuity carrier, then
b. Calculating a tax-free portion of annual income ($taxfreeincomelife) in this way: $aabenefitlife−$taxableincomelife, then
c. Calculating a tax exclusion ratio ($taxexclratiolife) in this way: (1−(taxableincomelife/$aabenefitlife)), then
d. Calculating a SPIA payout ($spiapay) in this way: ($aabenefitlife/$tgaamount), then
e. Calculating a donor gift amount ($donorgift) in this way: ($tgaamount−($aabenefit/$spiapay)), then
f. Letting an income tax deduction ($ideductionlife) equal $donorgift, then
g. Calculating an income tax savings ($taxsavingslife) in this way: ($ideductionlife*($taxrate/100)), then
h. Calculating a taxable portion of a SPIA with ACGA Payout ($taxspia) in this way: (($taxableincomelife/$aabenefitlife)*$aabenefit); then
i. Calculating a tax-free portion of a SPIA with ACGA Payout ($taxfreespia) in this way: ($aabenefit−$taxspia).

17. The method of claim 16, wherein the second annuity product comprises an immediate gift annuity for life only, without principal guarantee.

18. The method of claim 11, wherein using the second set of annuity carrier information comprises:
a. Retrieving from the database a highest payout ($aabenefitlifecash) and a lowest tax ($taxableincomelifecash, then
b. Calculating a tax-free portion of annual income ($taxfreeincomelifecash) in this way: $aabenefitlifecash−$taxableincomelifecash), then
c. Calculating a tax exclusion ratio ($taxexclratiolifecash) in this way: (1−$taxableincomelifecash/$aabenefitlifecash)), then
d. Calculating a SPIA payout ($spiapaycash) in this way: ($aabenefitlifecash/$tgaamount), then
e. Calculating a donor gift amount ($donorgiftcash) in this way: ($tgaamount−($aabenefit/$spiapaycash)), then
f. Letting an income tax deduction ($ideductionlifecash)=$donorgiftcash, then
g. Calculating an income tax savings ($taxsavingslifecash) in this way: ($ideductionlifecash*($taxrate/100)), then
h. Calculating a taxable portion of a SPIA with ACGA Payout ($taxspiacash) in this way: (($taxableincomelifecash/$aabenefitlifecash)*$aabenefit), then
i. Calculating a tax-free portion of a SPIA with ACGA Payout ($taxfreespiacash) in this way: ($aabenefit−$taxspiacash), then
j. Calculating a life expectancy cash ($lifeexp) in this way: ($tgaamount/$taxfreeincomelifecash).

19. The method of claim 18, wherein the third annuity product comprises an immediate gift annuity with principal guarantee.

20. The method of claim 11, wherein the database stores: end user authentication credentials, end user contact information, the government financial index, the professional association financial index, biographical information of the prospective donor, financial information of the prospective donor, and proposals.
